(19) United States
(12) Patent Application Publication
(10) Pub. No.: US 2002/0009943 A1
(43) Pub. Date: Jan. 24, 2002

(54) PROCESS FOR MANUFACTURING A FIELD EMISSION CATHODE

(76) Inventor: FUMINORI ITO, TOKYO (JP)

Correspondence Address: MCGUIRE WOODS, LLP, 1750 TYSONS BOULEVARD SUITE 1800, MCLEAN, VA, 22102-4215, US

(21) Appl. No.: 09/200,988

(22) Filed: Nov. 30, 1998

(30) Foreign Application Priority Data
Dec. 1, 1997 (JP) 330247/1997

(51) Int. Cl. H01J 9/02

(52) U.S. Cl. 445/24; 445/50

(57) ABSTRACT

An insulating layer 2 and a gate electrode layer 1 are sequentially formed on a conductive substrate 3; then the insulating layer 3 and the gate electrode layer 1 are etched to form an opening extending to the conductive substrate 3; then an emitter material is deposited on the surfaces of the conductive substrate 3 and of the gate electrode layer 1 which are exposed on the bottom of the said opening from a direction vertical to the conductive substrate 3, to form a sharp emitter tip 5 within the opening; and finally the emitter material deposited on the upper face of the gate electrode layer 1 is removed, to provide a field emission cathode.

### BACKGROUND OF THE INVENTION

1. Field of the Invention

This invention relates to a field emission cathode which may be used as an electron beam source for a variety of electron beam devices such as a flat panel display, a CRT, an electron microscope and an electron beam exposure device.

2. Description of the Related Art

Recently, a field emission cathode has been intensively studied and developed, in which a conductive substrate, an insulating layer, a gate electrode layer and a cathode emitter with a sharp tip within the openings thereof may be formed as an integrated part using a semiconductor fine processing technology. Such a cathode is expected to be applied to a high-performance electron gun.

As an example of a manufacturing technique for a conventional field emission cathode, Spindt et al. has described a process for manufacturing a field emission cathode using molybdenum with a high melting point in view of generation of an increased radiation current density and controllability in the Journal of Applied Physics, Vol.47 (1976), p.5248, which is herein shown in FIG. 2. First, on a highly N-type doped silicon substrate(conductive substrate 3) are sequentially deposited an insulating layer 2 consisting of SiO₂ and a gate electrode l(FIG. 2(a)), and a circular opening is formed via etching(FIG. 2(b)). Then, as shown in FIG. 2(c), the insulating layer 2 within the opening is etched with hydrofluoric acid to increase only the opening diameter in the insulating layer 2. Then, rotating the substrate, an aluminum layer is deposited by oblique injection(FIG. 2(d))(hereinafter, the aluminum layer is referred to as a “sacrificing layer” 4). The sacrificing layer 4 is formed only on the upper face and the side wall of the gate electrode layer 1. After forming the sacrificing layer 4, a molybdenum layer 6 as an emitter material is deposited from a vertical direction to the substrate by means of an appropriate procedure such as a vapor deposition technique. As the molybdenum layer 6 is deposited, molybdenum is gradually condensed around the opening of the sacrificing layer, leading to reduction of the opening diameter and then blockage of the opening. At the same time, a cone shape of emitter 5 is formed on the conductive substrate 3(FIG. 2(e)). The sacrificing layer 4 and the molybdenum layer 6 deposited on the sacrificing layer 4 are simultaneously removed by etching. Thus, finally, a corn shape of emitter 5 with a sharp tip is left within the opening in the insulating layer 2 and the gate electrode layer 1 formed on the conductive substrate(FIG. 2(f)). They have described that a plurality of such emitters may be placed and that applying a gate voltage of 100 to 300 V to the tip in relation to the emitter potential may allow electrons of about 50 to 150 μA per a chip to be emitted in the vacuum atmosphere.

The above manufacturing process of a field emission cathode using a sacrificing layer makes it easier to form an emitter and to remove an unnecessary emitter material deposited on the top layer. Such a technique, however, has the following problems due to a sacrificing layer.

First, the quality of the sacrificing layer and the shape of the opening of the sacrificing layer cannot be adequately controlled, causing a irregular shape of the emitter and thus nonuniformity of the emission current. The shape of the emitter formed within the gate opening significantly depends on the shape of the opening after depositing the sacrificing layer. Therefore, if the opening in the sacrificing layer is deformed from a circle, the emitter formed may become deformed, reflecting the shape of the sacrificing layer or the tip of the emitter may be displaced from a normal position. Since the field intensity varies depending on the shape of the tip of the emitter and the tip position of the emitter in relation to the gate electrode, electron emission properties from the emitter formed via a sacrificing layer may become uneven, leading to reduction in an yield and product quality. Furthermore, since the sacrificing layer is deposited via oblique injection with rotating the substrate, the procedure may become more sophisticated and additionally expensive devices with high controllability may be needed. Thus, the manufacturing process of the prior art may lead to a higher cost and a lower throughput.

Secondly, in the process of the prior art, the distance between the gate and the emitter cannot be allowed to be adequately narrow due to the presence of the sacrificing layer. As shown in FIG. 4, when an emitter with a height of L and an emitter-tip angle of θ is to be formed, the thickness t of the sacrificing layer 4 is determined according to the values of L and θ. Since the sacrificing layer 4 covers the sidewall of the opening of the gate electrode 1, the diameter d of the opening after forming the sacrificing layer is narrower than the diameter d^{†} before forming the sacrificing layer by 2t. Thus, the distance between the end of the gate electrode layer 1 and the tip of the emitter is longer than that without the sacrificing layer by t. The initial voltage for field emission cannot be, therefore, adequately reduced and an operating voltage may be increased.

### SUMMARY OF THE INVENTION

This invention for solving the above problems provides a process for manufacturing a field emission cathode, comprising the steps of

sequentially forming an insulating layer and a gate electrode layer on a conductive substrate;

etching the insulating layer and the gate electrode layer to form an opening extending to the conductive substrate;

depositing an emitter material on the surfaces of the conductive substrate and of the gate electrode layer which are exposed on the bottom of the said opening from a direction vertical to the conductive substrate, to form a sharp emitter tip within the opening; and

removing the emitter material deposited on the upper face of the gate electrode layer.

According to the process for manufacturing a field emission cathode of this invention, an emitter is directly formed via a gate electrode layer without using a sacrificing layer, leading to a shortened process, and controllability for the shape and the tip position of the emitter can be improved, leading to a uniform emission current and improvement in a productivity and quality. Furthermore, reduction of the distance between the gate and the emitter may give good electron-emitting properties with a lower voltage.

In brief, according to this invention,

i) an emitter material is directly deposited via an opening formed in a gate electrode layer without using a sacrificing layer during emitter-layer formation, leading to a shortened manufacturing process;

ii) controllability for the shape and the tip position of the emitter can be improved, leading to a uniform emission current and improvement in a productivity and quality; and

iii) reduction of the distance between the gate and the emitter may allow a smaller emitter to be manufactured, leading to good electron-emitting properties with a lower voltage.

### BRIEF DESCRIPTION OF THE DRAWINGS

FIG. 1 illustrates a manufacturing process for a field emission cathode according to this invention.

FIG. 2 illustrates a manufacturing process for a field emission cathode according to the prior art.

FIG. 3 illustrates the cross-sectional structure of the field emission cathode according to this invention.

FIG. 4 illustrates the cross-sectional structure of the field emission cathode according to the prior art.

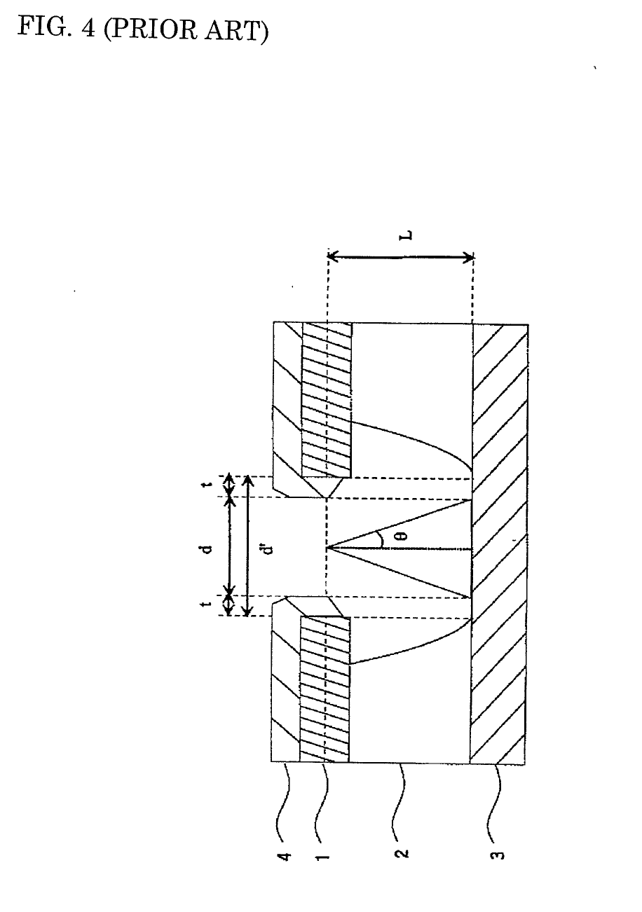

### DETAILED DESCRIPTION OF THE PREFERRED EMBODIMENTS

This invention will be specifically described with an example.

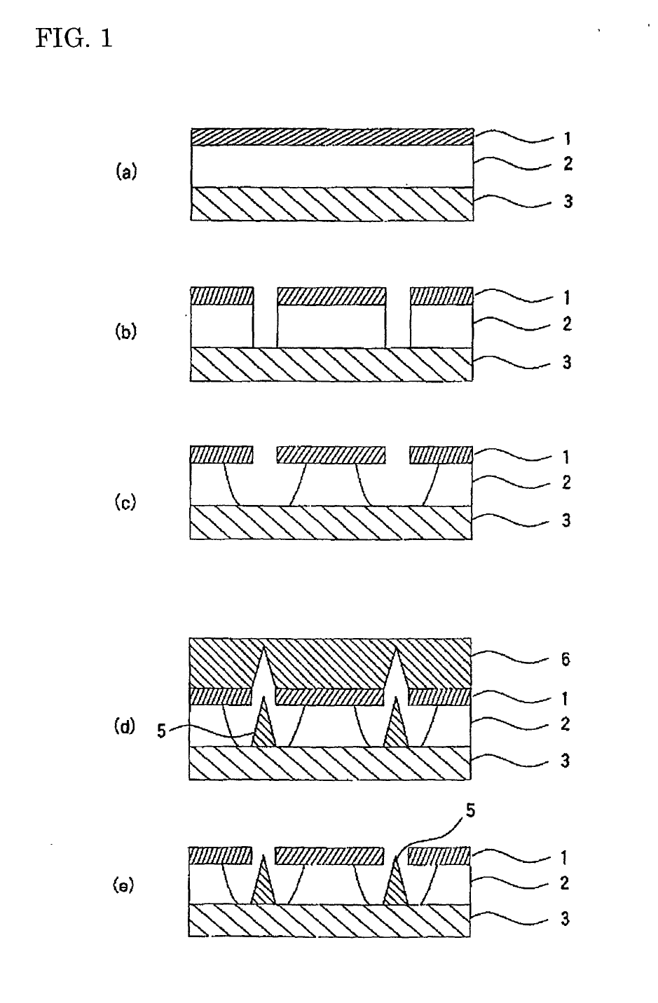

FIG. 1 shows a cross-sectional structure of the field emission cathode manufactured according to this invention. On a highly N-type doped silicon substrate(conductive substrate 3) are sequentially deposited an insulating layer 2 consisting of SiO₂ with a thickness of 500 nm and a gate electrode 1 consisting of molybdenum with a thickness of 200 nm(FIG. 1(a)), and a plurality of circular openings are formed via etching(FIG. 1(b)). The gate electrode layer may be composed of a conductive metal, alloy or intermetallic compound. The diameter of the openings is herein 700 nm. Then, the insulating layer 2 within the opening in the gate electrode is etched with hydrofluoric acid to increase only the opening diameter in the insulating layer 2 as shown in FIG. 1(c). Then, molybdenum as an emitter material is deposited from a direction vertical to the substrate by vacuum deposition under high vacuum. In contrast, molybdenum is deposited by oblique injection in the prior art.

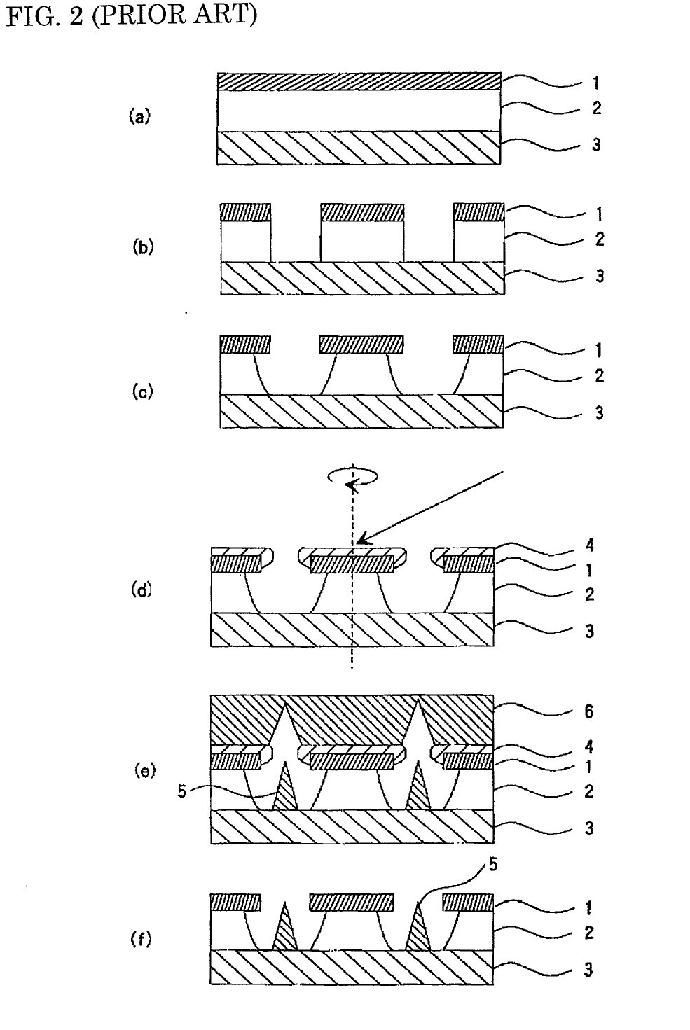

As molybdenum layer is deposited, it is gradually condensed around the opening of the gate electrode layer, and thus increase of the film thickness leads to reduction of the opening diameter and then blockage of the opening. At the same time, a cone shape of emitter 5 is formed on the conductive substrate (FIG. 1(d)). The molybdenum layer 6 deposited on the gate electrode 1 is then polished by an appropriate procedure such as a Chemical Mechanical Polishing(CMP) technique, to provide a sharp cone shape of emitter 5 within the opening in the insulating and the gate electrode layers formed on the conductive substrate as shown in FIG. 2(e). Polishing of the molybdenum layer 6 must be continued until the surface of the gate electrode 1 is exposed. The degree of polishing may be controlled according to a polishing duration. For controlling the degree of polishing with a high accuracy, for example, a nitride layer may be formed on the gate electrode layer 1 using a CVD technique in the step of FIG. 1(a), which is used as a stopper during polishing.

Compared with the prior art shown in FIG. 2, the process of this invention does not use a sacrificing layer during forming an emitter, resulting in shortening the process, as well as forms an emitter utilizing a gate opening without a sacrificing layer, allowing the shape to be uniformly controlled.

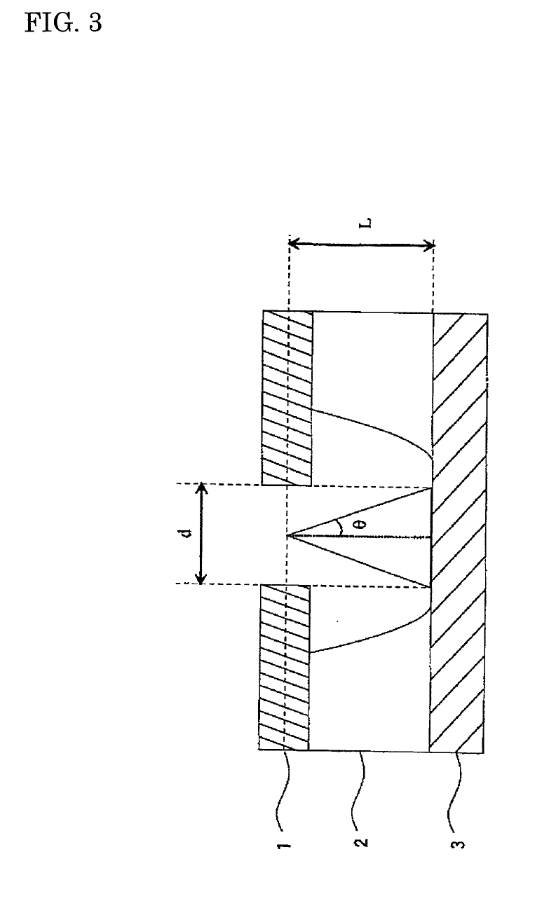

In the process of this invention, compared with the prior art, increase of the distance between the gate and the emitter due to the film thickness during formation of the emitter can be avoided. As shown in FIG. 3, in this invention, the emitter tip angle θ depends on the condensation rates of molybdenum in directions vertical and parallel to the substrate. In other words, the emitter tip angle θ does not depend on the diameter of the gate opening. Therefore, the diameter d of the gate opening may be selected so that d meets the following relationship with the emitter height L; d=2Ltan θ. The emitter tip angle θ depends on the conditions of molybdenum deposition, and herein was about 30°. For example, when a device is designed in a manner that the thickness of the insulating layer is 500 nm, the thickness of the gate electrode layer is 200 nm, and the emitter tip along the height direction of the device is at the same position as that of the center of the gate electrode layer, the diameter of the gate opening is 700 nm according to the above relationship. The dimensions indicated in the example were estimated based on such a calculation. Furthermore, when the emitter height L is reduced, the distance between the gate and the emitter is necessarily reduced. Reduction of the emitter height, however, causes reduction in the thickness of the insulating layer 2 responsible for insulation of the gate electrode and the substrate. In this example, the emitter height L was selected in the light of a withstand voltage, i.e., a thickness of the insulating layer sufficient to avoid breakdown of the device.

In contrast, in the procedure of the prior art using a sacrificing layer, it is required to design the opening of the gate electrode with a diameter larger than the desired one by the thickness t of the sacrificing layer. In brief, when the emitter height L is constant, the process of the prior art requires a margin in the diameter of the gate opening, corresponding to 2t, and therefore, the substantial diameter of the opening must be larger than that in this invention by 2t.

Specifically, when the thickness at the opening of the sacrificing layer is 150 nm, the device of this invention may achieve reduction of the gate diameter by 300 nm in relation to the device of the prior art. In addition, whereas the diameter of the gate opening cannot be reduced below 2t in the prior art, this invention may allow an emitter with a smaller gate opening to be formed. Thus, the process of this invention without a sacrificing layer can shorten the process, makes device design easier, and reduce the distance between the gate and the emitter compared with the prior art.

What is claimed is:

1. A process for manufacturing a field emission cathode, comprising the steps of
sequentially forming an insulating layer and a gate electrode layer on a conductive substrate;
etching the insulating layer and the gate electrode layer to form an opening extending to the conductive substrate;
depositing an emitter material on the surfaces of the conductive substrate and of the gate electrode layer which are exposed on the bottom of the said opening from a direction vertical to the conductive substrate, to form a sharp emitter tip within the opening; and
removing the emitter material deposited on the upper face of the gate electrode layer.

2. A process for manufacturing a field emission cathode as is claimed in claim 1, wherein the emitter material deposited on the upper face of the gate electrode layer is removed by a Chemical Mechanical Polishing(CMP) technique.

3. A process for manufacturing a field emission cathode as is claimed in claim 1, wherein after forming the gate electrode layer, a stopper layer is formed on the upper face of the gate electrode layer.

4. A process for manufacturing a field emission cathode as is claimed in claim 3, wherein the stopper layer is a nitride film.

5. A field emission cathode manufactured by the process as is claimed in claim 1.
